(19) United States
(12) Patent Application Publication
(10) Pub. No.: US 2009/0293852 A1
(43) Pub. Date: Dec. 3, 2009

(54) Emission Control System with Vacuum Boost

(76) Inventors: Ian James Frick, Oakdale, MN (US); Henry Joseph Drasner, Chaska, MN (US)

Correspondence Address: MERCHANT & GOULD PC, P.O. BOX 2903, MINNEAPOLIS, MN, 55402-0903, US

(21) Appl. No.: 12/466,210

(22) Filed: May 14, 2009

Related U.S. Application Data
(60) Provisional application No. 61/054,828, filed on May 21, 2008.

(51) Int. Cl. F02B 25/06

(52) U.S. Cl. 123/573

(57) ABSTRACT

The present disclosure relates to a closed crankcase emission control system that includes an engine. The closed crankcase emission control system also includes a turbo disposed upstream from the engine that is in fluid communication with the engine. The closed crankcase emission control system further includes an air filter disposed upstream from the turbo that is in fluid communication with the turbo. Additionally, the closed crankcase emission control system includes a blow-by filter arrangement disposed downstream of the engine and upstream from the turbo. The blow-by filter arrangement is adapted for filtering blow-by gases from the engine. Furthermore, the closed crankcase emission control system has a diameter restriction disposed between the turbo and the air filter that is in fluid communication with the air filter, the turbo, and the blow-by filter. The turbo draws air from the air filter and a filtered gaseous stream from the blow-by filter arrangement through the diameter restriction.

### CROSS REFERENCE TO RELATED APPLICATION

This application claims the benefit of U.S. Provisional Patent Application Ser. No. 61/054,828, filed May 21, 2008, which application is hereby incorporated by reference in its entirety.

### BACKGROUND

Blow-by gases are created by pressure leakage passed piston rings and by reciprocating motion of pistons. A draft tube from the crankcase emits blow-by in the form of aerosol and coalescence droplets. Chemically, these blow-by emissions are in the form of oil droplets, carbon soot, and debris from wear for fugitive dust. Physically, typically about 50% of the mass is less than one micrometer.

There are various systems that use open crankcase engines. These include heavy duty trucks and buses; light vehicles; off-road mobile vehicles; off-road equipment (e.g. industrial equipment, generators); and marine engines.

Tailpipe emissions include gases, particulate matter, and aerosols. These exhaust streams include hydrocarbons, carbon monoxide, soot, oxides of nitrogen, nitric oxide, nitrogen dioxide, particulate matter, sulfate, and other material.

### SUMMARY

An aspect of the present disclosure relates to an emission control system. The emission control system including a blow-by filter arrangement and a diameter restriction in fluid communication with the blow-by filter arrangement.

Another aspect of the present disclosure relates to an emission control system. The emission control system includes an engine, an air filter, a turbo, a blow-by filter arrangement, and a diameter restriction. The turbo is disposed upstream from the engine and is in fluid communication with the engine. The air filter is disposed upstream from the turbo and being in fluid communication with the turbo. The blow-by filter arrangement is disposed downstream of the engine and upstream from the turbo. The blow-by filter arrangement is adapted for filtering blow-by gases from the engine. The diameter restriction is disposed between the turbo and the air filter. The diameter restriction is in fluid communication with the air filter, the turbo and the blow by filter. The turbo draws air from the air filter and a filtered gaseous stream from the blow-by filter arrangement through the diameter restriction.

Another aspect of the present disclosure relates to a method for retrofitting a diesel engine. The method includes installing a blow-by filter for filtering blow-by gas generated by the diesel engine to reduce blow-by gas emission. The blow-by filter is installed in fluid communication with a breather port of a diesel engine. The method further includes installing a diameter restriction between an air filter and a turbo, wherein the diameter restriction is in fluid communication with the air filter, the turbo, and the blow-by filter. The diameter restriction being adapted so that the turbo draws air from the air filter and a filtered gaseous stream from the blow-by filter arrangement through the diameter restriction.

Another aspect of the present disclosure relates to a method for reducing pressure in a crankcase of an engine having a closed crankcase configuration. The method includes placing a diameter restriction in an air intake system. The method further includes drawing air through the diameter restriction such that a vacuum is created in the air intake system.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### DRAWINGS

FIG. 1 is a schematic view of a prior art emission control system.

FIG. 2 is a cross-sectional view of a blow-by filter arrangement suitable for use in the prior art emission control system of FIG. 1 and the emission control system of FIGS. 4 and 5.

FIG. 3 is a graphical representation of pressure in a crankcase of an engine of the prior art emission control system over service life of the blow-by filter arrangement of FIG. 2.

FIG. 4 is a schematic representation of an emission control system having features that are examples of aspects in accordance with the principles of the present disclosure.

FIG. 5 is a schematic representation of an alternate embodiment of the emission control system of FIG. 1.

FIG. 6 is a graphical representation of pressure in a crankcase of an engine of the emission control system of FIG. 5 over the service life of the blow-by filter arrangement of FIG. 2.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

Pressure-charged diesel engines often generate “blow-by” gases, i.e., a flow of air-fuel mixture leaking past pistons from the combustion chambers. Such “blow-by gases” generally comprise a gas phase, for example air or combustion off gases, carrying therein: (a) hydrophobic fluid (e.g., oil including fuel aerosol) principally comprising 0.1-5.0 micron droplets (principally, by number); and, (b) carbon contaminant from combustion, typically comprising carbon particles, a majority of which are about 0.1-10 microns in size. Such “blow-by gases” are generally directed outwardly from the engine block, through a blow-by vent.

Exhaust gases are produced in the engine as part of the combustion process. The exhaust gases are directed out of the engine and through a tailpipe. Together, the blow-by gases and tailpipe emissions represent a total emissions volume being released from the engine.

Herein when the term “hydrophobic” fluids is used in reference to the entrained liquid aerosol in gas flow, reference is meant to nonaqueous fluids, especially oils. Generally such materials are immiscible in water. Herein the term “gas” or variants thereof, used in connection with the carrier fluid, refers to air, combustion off gases, and other carrier gases for the aerosol.

The gases may carry substantial amounts of other components. Such components may include, for example, copper, lead, silicone, aluminum, iron, chromium, sodium, molybdenum, tin, and other heavy metals.

Engines operating in such systems as trucks, farm machinery, boats, buses, and other systems generally comprising diesel engines, may have significant gas flows contaminated as described above. For example, flow rates and volumes on the order of 2-50 cubic feet per minute (cfm), typically 5 to 10 cfm, are fairly common.

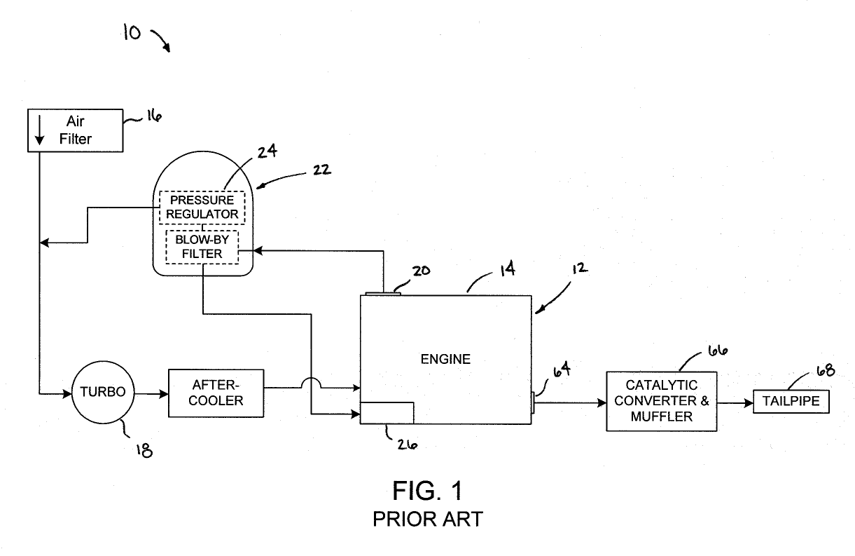

Referring now to FIG. 1, a schematic representation of a prior art emission control system 10 is shown. The prior art emission control system 10 has been described in U.S. Pat. No. 7,257,942, which is hereby incorporated by reference in its entirety. In the subject embodiment, the prior art emission control system 10 is depicted in a closed crankcase configuration (CCC).

The prior art emission control system 10 includes a turbocharged diesel engine 12. The engine 12 includes a crankcase or body 14 in which is disposed a plurality of components (e.g., pistons, intake valve, exhaust valve, connecting rod, etc.) of the engine 12. Air is taken to the engine 12 through an air filter (or cleaner) 16, which cleans the air taken in from the atmosphere.

A turbo 18 draws the clean air from the air filter 16 and pushes it into engine 12. While in engine 12, the air undergoes compression and combustion by engaging with pistons and fuel.

During the combustion process, the engine 12 gives off blow-by gases through a vent or breather port 20. A blow-by filter arrangement 22 is in gas flow communication with the vent 20 and cleans the blow-by gases to produce filtered gases. The filtered gases from the blow-by filter arrangement 22 are directed through a pressure regulator 24, which is integrated with the filter arrangement 22. From there, the filtered gases are pulled through by the turbo 18 and into the engine 12. Oil recovered from the blow-by filter arrangement 22 is directed to an oil sump 26.

In the subject embodiment, the pressure regulator 24 is a pressure valve that regulates the amount of pressure in the crankcase 14 of the engine 12. In response to increasing pressure in the crankcase 14 of the engine 12 as a result of a plugged blow-by filter arrangement 22, the pressure regulator 24 opens in an attempt to maintain the pressure in the crankcase 14 below a certain value. In response to decreasing pressure in the crankcase 14, the pressure regulator 24 closes in an attempt to limit excess vacuum during operation of the turbo 18.

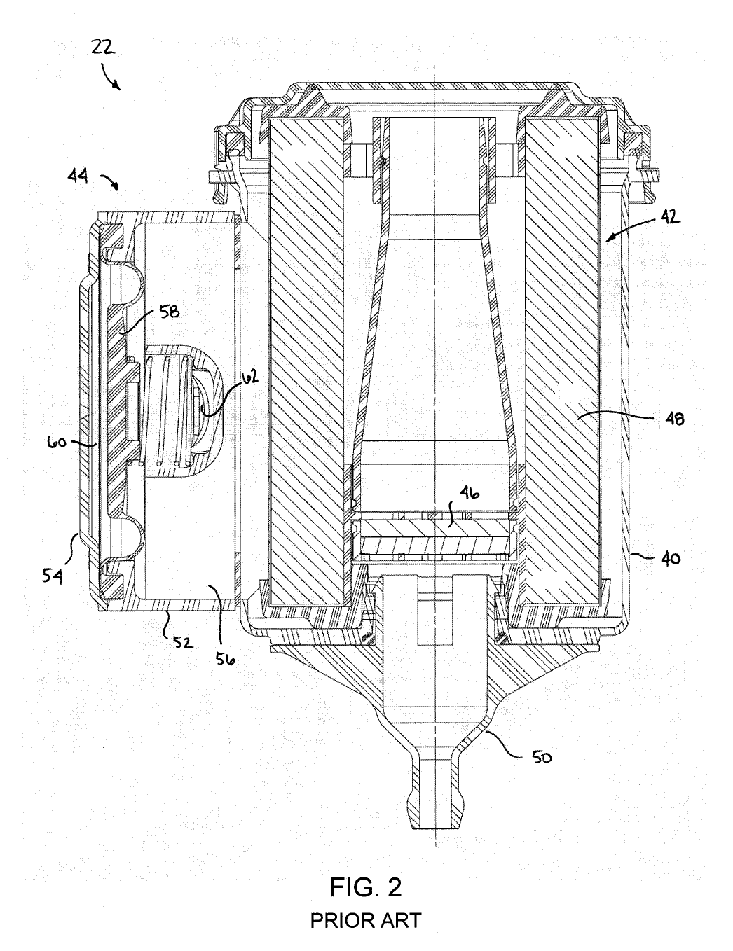

Referring now to FIG. 2, an embodiment of the blow-by filter arrangement 22 has been described in U.S. Pat. No. 7,257,942, the disclosure of which is hereby incorporated by reference in its entirety. The blow-by filter arrangement 22 separates a hydrophobic liquid phase from a gaseous stream. This reduces crankcase emissions over systems lacking such a filter. In combination with a catalytic converter muffler, overall emissions (crankcase and tailpipe) are reduced. In operation, a contaminated gas flow is directed into the blow-by filter arrangement 22. Within the blow-by filter arrangement 22, the fine oil phase or aerosol phase (i.e., hydrophobic phase) coalesces. The blow-by filter arrangement 22 is constructed so that as the hydrophobic phase coalesces into droplets, it will drain as a liquid such that it can readily be collected and removed from the system. In one embodiment, the blow-by filter arrangement 22 includes a housing 40 holding a removable and replaceable filter element 42 and a valve housing subassembly 44.

In the subject embodiment, the filter element 42 includes a first stage coalescer filter 46 and a second stage filter media 48. In use, a liquid entrained gaseous stream is routed through the first stage coalescer filter 46, in which a portion of the liquid phase is coalesced and removed from the gaseous stream by the first stage coalescer filter 46. The liquid that is coalesced within the first stage coalescer filter 46 drains and exits the housing 40 through a first fluid port 50.

The gaseous stream is directed through the second stage filter media 48. The second stage filter media 48 removes at least a portion of the particulates from the gaseous stream. The cleaned gaseous stream is then routed into the valve housing subassembly 44.

The valve housing subassembly 44 includes a valve housing body 52 and a valve housing cover 54. The valve housing body 52 defines an interior volume 56 in which is disposed the pressure regulator 24.

In the subject embodiment, the pressure regulator 24 includes a diaphragm 58 that is operably oriented between the valve housing cover 54 and the valve housing body 52. Between the diaphragm 58 and the valve housing cover 54 is an open volume 60. In operation, when the blow-by filter arrangement 22 has sufficient pressure therewithin, the diaphragm 58 elastically deforms to occupy the open volume 60. As the diaphragm 58 deforms, a second fluid port 62 opens thereby allowing the cleaned gaseous stream to flow out the second fluid port 62.

In alternative embodiments, the blow-by filter arrangement 22 can be embodied as described in U.S. Pat. Nos. 6,852,148, 6,540,801, 6,530,969, 6,355,076, 6,290,739, 6,171,355, 6,143,049 and 5,853,439, all of which are hereby incorporated by reference in their entirety.

Referring again to FIG. 1, exhaust gases from the engine 12 are directed through an exhaust port 64 downstream to a diesel oxidation catalyst arrangement, embodied herein as a catalytic converter and muffler 66. The catalytic converter and muffler 66 includes a catalyst that allows for the oxidation of hydrocarbons in the gaseous phase, thereby reducing the concentration of hydrocarbons in the exhaust stream. Due to the concentration reduction, a lower amount of hydrocarbons would be adsorbed onto the surface of the carbonaceous particles or soot in the stream. Thus, there is a mass reduction in the tailpipe emissions when the catalytic converter is utilized. The muffler 66 operates to reduce the sound pressure level emanating from the engine. In one embodiment, the muffler 66 includes a catalyzed diesel particulate filter. From the catalytic converter and muffler 66, the exhaust gases are emitted from a tailpipe 68.

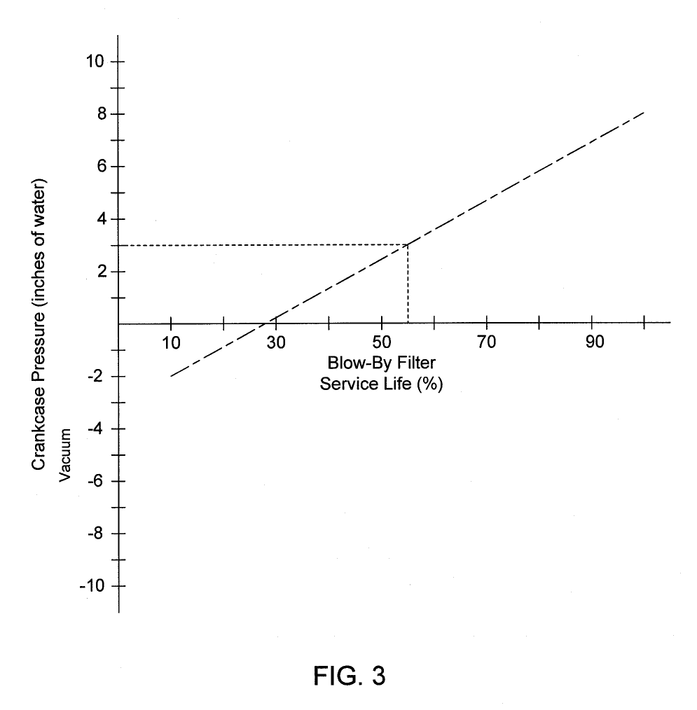

Referring now to FIG. 3, a graph of pressure (measured in inches of water) in the crankcase 14 of the engine 12 over a service life percentage of the blow-by filter arrangement 22 is shown. In one embodiment, the service life percentage is calculated by the current life of the blow-by filter arrangement divided by the rated life of the blow-by filter arrangement, where life can be measure in hours, usage, etc. For example, a low service life percentage of the blow-by filter arrangement 22 indicates a blow-by filter arrangement 22 that is toward the beginning of its lifespan while a high service life percentage indicates a blow-by filter arrangement that is toward the end of its lifespan.

As the service life of the blow-by filter arrangement 22 increases, the flow resistance through the blow-by filter arrangement 22 also increases. The increase in the flow resistance through the blow-by filter arrangement 22 is due to the collection of blow-by contaminants, such as soot particles from the diesel combustion process. As the flow resistance through the blow-by filter arrangement 22 increases, the pressure in the crankcase 14 increases. For example, in the subject embodiment, the pressure in the crankcase 14 of the prior art emission control system 10 at full load rated speed of the engine 12 is at about −2 inches of water (i.e., vacuum) when the blow-by filter arrangement 22 is at a clean state (e.g., the beginning of its life) and about 8 inches of water when the blow-by filter arrangement 22 is at an end-of-life state. Therefore, in the subject embodiment, and by way of example only, the blow-by filter arrangement 22 has a pressure differential of 10 inches of water between the clean state and the end-of-life state.

While the prior art emission control system 10 is effective for use with many different engines 12, some engines 12 may experience oil leaks from crankcase seals if the pressure in the crankcase 14 exceeds a given amount. For example, in some engines 12, if the pressure in the crankcase 14 exceeds 3 inches of water, engine leaks may develop.

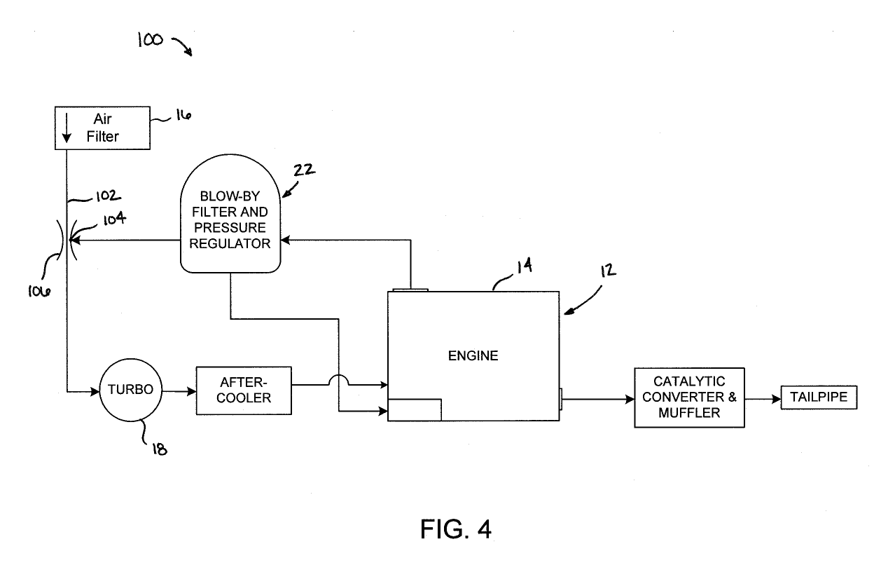

Referring now to FIG. 4, an emission control system 100 is shown. In the subject embodiment, the emission control system 100 includes the turbocharged diesel engine 12, the air filter 16, the turbo 18 and the blow-by filter arrangement 22. The turbo 18 draws the clean air from the air filter 16 and pushes it into the engine 12. The turbo 18 also draws the cleaned gaseous stream from the blow-by filter arrangement 22 and pushes it into the engine 12. In the depicted embodiment of FIG. 4, the cleaned gaseous stream from the blow-by filter arrangement 22 is drawn into a fluid passage 102 that provides fluid communication between the air filter and the turbo 18 through a fluid passage inlet 104.

In the subject embodiment, the emission control system 100 further includes a diameter restriction 106. The diameter restriction 106 is disposed between the air filter 16 and the turbo 18. As fluid flows through the diameter restriction 106, the velocity of the fluid increases through the restriction while the pressure of the fluid decreases. This decrease in fluid pressure creates a low pressure region at the diameter restriction 106. In the subject embodiment, the fluid passage inlet 104, which connects the blow-by filter arrangement 22 to the fluid passage 102, is positioned in this low pressure region of the diameter restriction 106.

As the turbo 18 is drawing cleaned air from the air filter 16, the low pressure region is formed at the diameter restriction 106. This low pressure region created by the diameter restriction 106 assists in drawing the cleaned gaseous stream from the blow-by filter arrangement 22 through the fluid inlet passage 104.

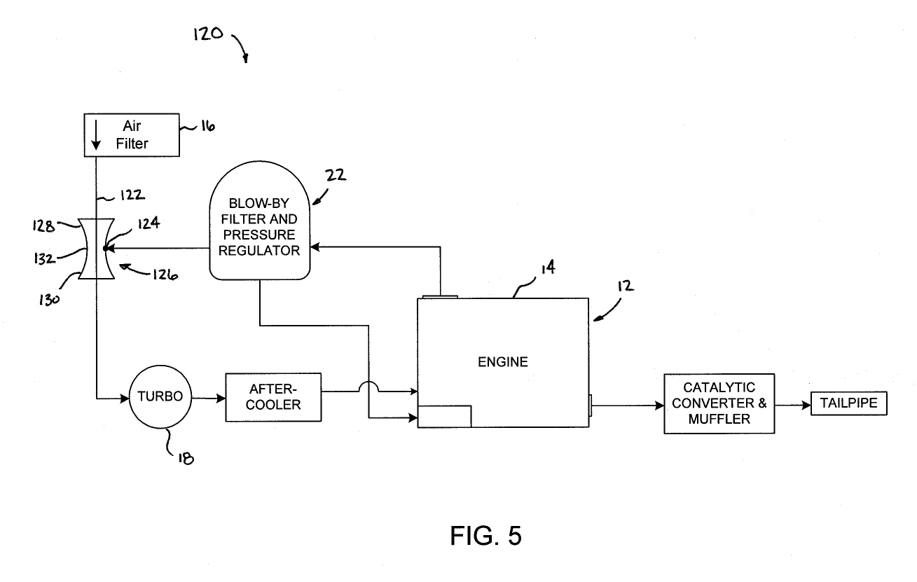

Referring now to FIG. 5, an alternate embodiment of an emission control system 120 is shown. In the subject embodiment, the emission control system 120 includes the turbocharged diesel engine 12, the air filter 16, the turbo 18 and the blow-by filter arrangement 22. In the depicted embodiment of FIG. 5, the air filter 16 is in fluid communication with the turbo 18 through a flow passage 122. The second fluid port 62 of the blow-by filter arrangement 22 is in fluid communication with the flow passage 122 through a flow passage inlet 124 disposed in the flow passage 122.

In the subject embodiment, the emission control system 120 further includes a Venturi restriction 126. The Venturi restriction 126 is disposed between the air filter 16 and the turbo 18. The Venturi restriction 126 includes an inlet portion 128, an outlet portion 130 and a restriction portion 132 disposed between the inlet and outlet portions 128, 130.

In one embodiment, the inlet portion 128 includes a first opening that is generally conically shaped. The first opening of the inlet portion 128 tapers toward the restriction portion 132. The outlet portion 130 includes a second opening that is generally conically shaped. The second opening of the outlet portion 130 tapers toward the restriction portion 132 such that the restriction portion 132 includes a diameter that is less than the diameters of the first and second openings. In the subject embodiment, the second fluid port 62 of the blow-by filter arrangement is in fluid communication with the restriction portion 132 of the Venturi restriction 126.

In operation, as the cleaned air from the air filter 16 passes through the Venturi restriction 126, the fluid velocity of the cleaned air increases. As the fluid velocity of the cleaned air increases, the fluid pressure decreases. In the restriction portion 132 of the Venturi restriction 126, the fluid pressure decreases resulting in an increased vacuum (i.e., decreased absolute pressure). As a result of the increase in vacuum the cleaned gaseous stream from the blow-by filter arrangement 22 is drawn into the Venturi restriction 126.

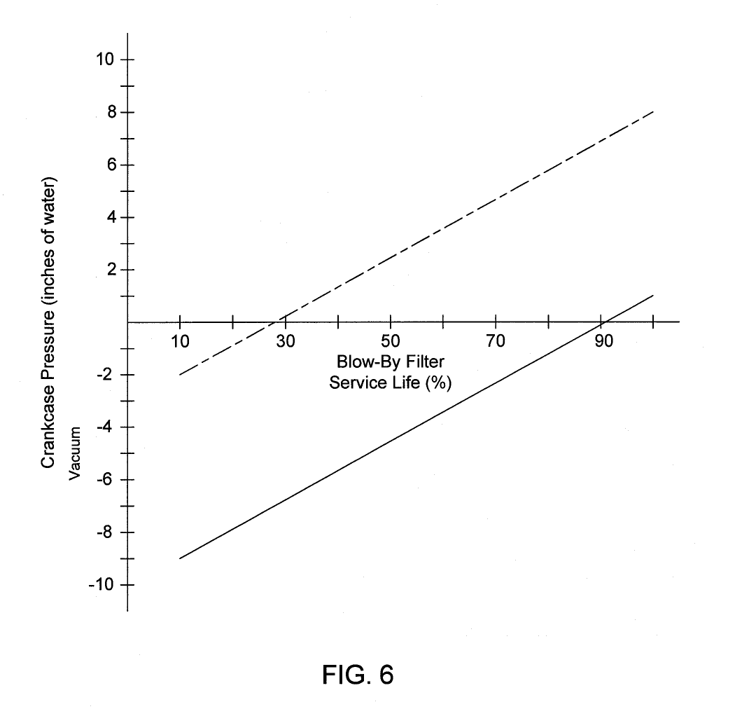

Referring now to FIG. 6, a graph of pressure (measured in inches of water) in the crankcase 14 of the engine 12 at full load rated speed of the engine 12 over a service life percentage of the blow-by filter arrangement 22 is shown. As a result of the vacuum, which is increased at the restriction portion 132 of the Venturi restriction 126, drawing the cleaned gaseous stream from the blow-by filter arrangement 22 into the Venturi restriction 126, the pressure in the crankcase 14 of the emission control system 120 is substantially reduced as compared to pressure in the crankcase 14 of the prior art emission control system 10. In one embodiment, with the blow-by filter arrangement 22 at the clean state (e.g., the beginning of its life), the pressure in the crankcase 14 at full load rated speed of the engine 12 is initially a vacuum. In another embodiment, with the blow-by filter arrangement 22 at the clean state, the pressure in the crankcase 14 at full load rated speed of the engine 12 is less than or equal to about −3 inches of water, less than or equal to about −5 inches of water, less than or equal to about −7 inches of water or less than or equal to about −9 inches of water. For example, as shown in FIG. 6, with the blow-by filter arrangement 22 at the clean state, the pressure in the crankcase 14 at full load rated speed of the engine 12 is about −9 inches of water.

In one embodiment, with the blow-by filter arrangement 22 at the end-of-life state, the pressure in the crankcase 14 at full load rated speed of the engine 12 is less than or equal to about 2 inches of water. In another embodiment, with the blow-by filter arrangement 22 at the end-of-life state, the pressure in the crankcase 14 at full load rated speed of the engine 12 is less than or equal to about 1.5 inches of water or less than or equal to about 1 inch of water. In the example shown in FIG. 6, with the blow-by filter arrangement 22 at the end-of-life state, the pressure in the crankcase 14 at full load rated speed of the engine 12 is about 1 inch of water.

In one embodiment, the blow-by filter arrangement 22 includes a pressure indicator that indicates when the pressure in the crankcase 14 has reached a predetermined value. In one embodiment, the pressure indicator is a visual indicator such as a light or a pop-up member. The pressure indicator alerts the operator that the filter element 42 of the blow-by filter arrangement 22 may need to be replaced.

While the pressure differential of the blow-by filter arrangement 22 between the clean state and the end-of-life state in the emission control system 200 is similar to the pressure differential of the blow-by filter arrangement in the prior art emission control system 10, the amount of pressure in the crankcase 14 at the end-of-life state is significantly lower in the emission control system 200. As shown in FIG. 6, and by way of example only, the pressure in the crankcase 14 at the end-of-life state in the emission control system 100 is 1 inch of water as opposed to 8 inches of water in the prior art emission control system 10.

This difference between the crankcase pressure in the prior art emission control system 10 versus the emission control system 120 is potentially advantageous as it allows the blow-by filter arrangement 22 to be retrofitted into a greater number of engine systems.

Referring now to FIGS. 4 and 5, a method for retrofitting a diesel engine will be described. The method includes installing the diameter restriction 106 between the air filter 16 and the turbo 18. In one embodiment, the diameter restriction 106 is a Venturi restriction 126 having a restriction portion 132. The method further includes installing the blow-by filter arrangement 22 for filtering blow-by gases generated by the engine 12. The blow-by filter arrangement 22 is installed such that the blow-by filter arrangement 22 is in fluid communication with the breather port 20 on the engine 12 and the restriction portion 132 of the Venturi restriction 126.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

What is claimed is:

1. A closed crankcase emission control system comprising:
an engine;
a turbo disposed upstream from the engine, the turbo being in fluid communication with the engine;
an air filter disposed upstream from the turbo, the air filter being in fluid communication with the turbo;
a blow-by filter arrangement disposed downstream of the engine and upstream from the turbo, the blow-by filter arrangement adapted for filtering blow-by gases from the engine;
a diameter restriction disposed between the turbo and the air filter, the diameter restriction being in fluid communication with the air filter, the turbo, and the blow-by filter, wherein the turbo draws air from the air filter and a filtered gaseous stream from the blow-by filter arrangement through the diameter restriction.

2. A closed crankcase emission control system as claimed in claim 1, wherein the diameter restriction is adapted to reduce pressure within a crankcase of the engine.

3. A closed crankcase emission control system as claimed in claim 2, wherein the diameter restriction is adapted to reduce the pressure within the crankcase to a value less than or equal to about 3 inches of water at full load rated speed of the engine when the blow-by filter is at an end-of-life state.

4. A closed crankcase emission control system as claimed in claim 1, wherein the diameter restriction is a Venturi restriction.

5. A closed crankcase emission control system as claimed in claim 4, wherein a restriction portion of the Venturi restriction is in fluid communication with the blow-by filter arrangement.

6. A method for retrofitting a diesel engine, the method comprising:
installing a blow-by filter for filtering blow-by gas generated by the diesel engine to reduce blow-by gas emissions, the blow-by filter being installed in fluid communication with a breather port of a diesel engine; and
installing a diameter restriction between an air filter and a turbo, wherein the diameter restriction is in fluid communication with the air filter, the turbo, and the blow-by filter, wherein the diameter restriction is adapted so that the turbo draws air from the air filter and a filtered gaseous stream from the blow-by filter arrangement through the diameter restriction.

7. A method for retrofitting a diesel engine as claimed in claim 6, wherein the diameter restriction is a Venturi restriction.

8. A method for reducing pressure in a closed crankcase of an engine, the method comprising:
placing a diameter restriction in an air intake system; and
drawing air through the diameter restriction such that a vacuum is created in the air intake system.

9. A method for reducing pressure in a closed crankcase of an engine as claimed in claim 7, wherein a pressure of the vacuum is less than or equal to about −3 inches of water at full load rated speed of the engine.

10. A method for reducing pressure in a crankcase of an engine as claimed in claim 7, wherein a pressure of the vacuum is less than or equal to about −5 inches of water at full load rated speed of the engine.

11. A method for reducing pressure in a crankcase of an engine as claimed in claim 7, wherein a pressure of the vacuum is less than or equal to about −7 inches of water at full load rated speed of the engine.

12. A method for reducing pressure in a crankcase of an engine as claimed in claim 7, wherein a blow-by filter arrangement is in fluid communication with a turbo through the diameter restriction.

13. A method for reducing pressure in a crankcase of an engine as claimed in claim 11, wherein the diameter restriction is a Venturi restriction.
